(19) United States
(12) Patent Application Publication
(10) Pub. No.: US 2006/0020452 A1
(43) Pub. Date: Jan. 26, 2006

(54) Noise generation apparatus

(75) Inventors: Hiroto Nakatani, Nagoya-city (JP); Teiyuu Kimura, Nagoya-city (JP); Noriyuki Ozaki, Kariya-city (JP); Minoru Makiguchi, Toyota-city (JP); Yoshiharu Yamamoto, Tokyo (JP)

Correspondence Address: POSZ LAW GROUP, PLC, 12040 SOUTH LAKES DRIVE, SUITE 101, RESTON, VA, 20191, US

(73) Assignees: Yoshiharu YAMAMOTO, Tokyo (JP); DENSO CORPORATION, Kariya-city (JP)

(21) Appl. No.: 11/189,086

(22) Filed: Jul. 26, 2005

(30) Foreign Application Priority Data
Jul. 26, 2004 (JP) 2004-217849
Dec. 17, 2004 (JP) 2004-366489

(51) Int. Cl. G10L 21/02

(52) U.S. Cl. 704/226

(57) ABSTRACT

A noise generator includes a noise intensity storage means for storing a noise intensity threshold of a noise, a noise intensity setting means for setting an optimum noise intensity based on the noise intensity threshold, a noise generation means for generating the noise based on the optimum noise intensity, and a noise output means for outputting the noise generated by the noise generation means. The noise generator determines the noise intensity threshold based on perception of the noise by a driver of an automotive vehicle.

### CROSS REFERENCE TO RELATED APPLICATION

This application is based on and claims the benefit of priority of Japanese Patent Application No. 2004-217849 filed on Jul. 26, 2004, and Japanese Patent Application No. 2004-366489 filed on Dec. 17, 2004, the disclosure of which is incorporated herein by reference.

### FIELD OF THE INVENTION

The present invention generally relates to a noise generation apparatus for generating a noise to assist a perceptive function of sensory organs.

### BACKGROUND OF THE INVENTION

In recent years, an automotive display device for warning an inattentive driving operation has been proposed (refer to Japanese Patent Document JP-A-2003-48453). In the disclosure of this Japanese Patent Document, the automotive display device uses a blinking image projected on a windshield to be viewed with a background scenery as a warning of inattention of a driver of a vehicle. The blinking image blinks in a frequency that is corresponding to critical harmony frequencies at a proximity of a center of the retina.

The blinking image provided for the driver by the automotive display device does not blink when the driver watches a traveling direction because visual signal of the blinking image enters into an eye of the driver towards a central vision. On the other hand, the blinking image blinks when the driver looks away from the traveling direction because the image is captured by a peripheral vision. In this manner, the automotive display device warns the driver of the vehicle that the attention of the driver is taken away from the driving direction. Further, perception of the blinking image by the driver serves as an environment that has an effect to attract the driver's vision toward the traveling direction of the vehicle.

However, the automotive display device described above causes disadvantages by directing the driver's vision only towards the traveling direction. That is, the driver tends to watch the traveling direction only, thereby reducing a chance to watch other directions. Therefore, for example, an object on the left or right of the vehicle that should collect driver's attention may be overlooked when the driver's vision is attracted to the traveling direction too strongly.

### SUMMARY OF THE INVENTION

In view of the above-described and other problems, it is an object of the present invention to provide a noise generation apparatus that improves driver's perception through the sensory organs in terms of awareness of an environment.

The noise generation apparatus of the present invention includes a noise intensity storage function for storing an intensity threshold of a noise that facilitates perception of an input signal in a target intensity range, an optimum noise setting function for setting an optimum intensity of the noise for output, a noise generation function for generating the noise having the optimum intensity and a noise output function for outputting a generated noise by the noise generation function.

The present invention is based on a research result regarding “Stochastic Resonance (SR),” disclosed in a thesis entitled “Functional stochastic resonance in the human brain: Noise induced sensitization of baroreflex system” by Hidaka et al., and published in Transaction on Bionics and Physiology Symposium Vol. 15, pp 261-264.

Stochastic resonance (SR) is a phenomenon that improves sensitivity of perception by statistically manipulating a small noise having an intensity below a threshold of perception for an organ of interest such as an eye, an ear or the like. Thus, SR is studied for improving human perception or a similar macro function. The area of improvement may include any macro facility such as perception, nerve control, behavioral operation or the like.

SR is more practically explained with reference to the drawings. FIG. 6A shows an illustration of a human sensory system (e.g., a nerve cell) having a non-linear response function. The human sensory system generally responds to an input having an intensity greater than a threshold by yielding an output, as shown in FIG. 6B. Therefore, an input having an intensity below the threshold cannot be detected. However, an input having an intensity below the threshold accompanied by a random noise in a broad frequency band can be perceived by the sensory organ with an assistance of SR effect. That is, SR increases the magnitude of the input and effectively improve the sensitivity of the human sensory system to detect an otherwise un-perceptible input.

An intensity of the random noise for improving the sensitivity should be carefully chosen in terms of its intensity range. FIG. 6C shows a relationship between a signal to noise ratio (SNR) and the random noise intensity. The relationship shown in the figure indicates that the random noise should neither be too strong nor too weak for perception of a signal of interest (i.e., an input). That is, a certain intensity of the random noise, i.e., an optimum intensity, will maximize the SNR.

An aspect of the present invention generates this random noise having the optimum intensity, and provide it, for example, in the driver's field of vision to facilitate perception of a condition around the vehicle. In this manner, the driver's attention is efficiently drawn to an object of interest around the vehicle for increased awareness of an environment.

The noise intensity storage function in the noise generation apparatus stores the intensity threshold of the random noise including an even distribution of frequency component in a broad band, and the optimum noise setting function controls the noise intensity based on the intensity threshold. That is, the optimum noise intensity of the random noise is set to a range of 100±18% of the intensity threshold, and the optimum noise intensity of the 1/f noise that is in inversely proportional relationship to an increase of frequency is set to a range of 69±12% of the intensity threshold.

The noise used to induce SR is, as described above, has to have a broad frequency band and randomness. That is, the noise does not have any peak point in terms of its intensity over a broad range of frequency component. Characteristics required for the random noise with the broad frequency band is described with reference to the drawings.

FIG. 7A shows a diagram of a relationship between the noise intensity and the intensity threshold for perception. The noise with the intensity below the threshold of perception cannot be perceived by a human sensory organ. This relationship also applies to an information signal inputted to a human sensory organ. As shown in FIG. 7B, the sensory organ only perceives a signal having the intensity greater than the threshold for perception.

However, the signal having the intensity below the threshold can be perceived when the signal and the noise resonate with each other as shown in FIG. 7C. This phenomenon is explained as SR. The signal of interest for the human sensory system usually does not have a constant attribute (defined value) in terms of frequency, intensity or the like when it is observed over a period of time. Therefore, another signal having a predetermined narrow band of frequency has very low chance to resonate with the signal of interest. In other words, the signal of interest can only resonate with a “noise” having randomness of intensity in a broad frequency band.

For example, the random noise having an even distribution of frequency component in a broad band in terms of the noise intensity, or the 1/f noise having the noise intensity in inversely proportional relationship to an increase of frequency may be used to induce SR between the signal of interest and the provided noise.

The optimum noise intensity of the random noise and the 1/f noise used to induce SR is preferably in a range close to the threshold of perception as shown in FIG. 7D. That is, the human sensory organ cannot perceive the signal of interest because of an insufficient resonance when the provided noise is too low in intensity, and cannot perceive the signal of interest because of overabundance of resonance when the provided noise is too high in intensity.

The optimum noise intensity is carefully examined through experiment by the inventors. Results of the experiment shows that the noise intensity of 100±18% of the intensity threshold for perception best serves for SR when the noise is the random noise, and the noise intensity of 69±12% of the intensity threshold for perception best serves for SR when the noise type is the 1/f noise.

The result of the experiment corresponds to a well-known general knowledge in the art of engineering that the 1/f noise yields the same effect as a “white noise,” i.e., a type of random noise, by approximately 70% of the intensity of the white noise. In this manner, the optimum noise intensity for various types of noises can be determined.

The intensity and type of the noise for inducing SR may be changed according to a degree of fatigue of the sensory organ or the like. This is because the noise provided for a period of time may cause reduction in sensitivity of the sensory organ. An adjustment of the intensity and/or type of the noise maintains effectiveness of SR.

The adjustment of the intensity and/or the type of the noise is performed based on an elapsed time measured by a clock. The adjustment is performed when the elapsed time surpasses a predetermined period. The predetermined period for adjustment may be determined based on an experiment or the like.

The adjustment of the noise intensity may further be based on a history of stored noise intensities. The history of the noise intensity may be used to determine the optimum noise intensity. The optimum noise intensity may be changed according to an average of the stored noise intensities. In this manner, difference of sensitivity among drivers of the vehicle may be reflected to the setting of the optimum noise intensity.

The driver of the vehicle may control adjustment of the noise intensity by using a control function. In this manner, the driver can set the optimum noise intensity according to his/her physical and mental health condition.

The noise intensity may be controlled in a gradually increasing manner or gradually decreasing manner to find the intensity threshold. The noise intensity at first recognition by the sensory organ in the course of increase may be determined and stored as the intensity threshold.

The noise generation apparatus of the present invention is intended for an automotive vehicle, and the generated noise is provided for the driver of the automotive vehicle.

The noise from the noise generation apparatus may be visually perceived by the driver of the vehicle. For example, the noise may be represented by flickering light or, as a change of a position of an object, and may be provided to a visual organ of the driver for inducing SR.

The noise from the noise generation apparatus may be outputted from a plurality of devices laterally arranged in a row in a front part of the vehicle ahead of a driver's seat. Spacing between of the plurality of the devices is within a width of the vehicle. In this manner, the noise is continuously provided in a visible area of the driver.

The noise from the noise generation apparatus may be outputted from a mirror surface of a rear view mirror or a room mirror to be perceived by the driver by vibrating the mirror surfaces of those mirrors.

The noise from the noise generation apparatus may be outputted from a headlight by controlling transparency of a liquid crystal shutter in front of the headlight. In this manner, the noise is provided for the driver as, for example, a change in brightness of light from the headlight.

The noise from the noise generation apparatus may be displayed on a display in a form of visual representation such as a light with various brightness, randomly arranged spots of light or the like.

The noise from the noise generation apparatus may be displayed on a display device such as a liquid crystal display disposed, for example, on the mirror surface of the rear view mirror by variably controlling emission attributes of light such as at least one of brightness, illuminance, luminosity, chroma, color and the like.

The noise from the noise generation apparatus may be displayed on a display device of a head-up display apparatus, a display device of a navigation system or a similar type of system. In this manner, the noise in a form of visual representation is outputted from a conventional device.

The noise from the noise generation apparatus may be provided in an audible form. The intensity threshold of an audible form of noise may be stored and used to generate the noise with the optimum noise intensity. The noise is provided for the driver of the vehicle through an auditory organ for inducing SR.

The noise from the noise generation apparatus may be provided for the driver of the vehicle through a source of sound disposed in the vehicle. That is, the source of sound may be a speaker, a buzzer or the like.

The noise from the noise generation apparatus may be provided for the driver of the vehicle as stimulation to a tactile organ. The intensity threshold of a tactual form of noise may be store and used to generate the noise with the optimum intensity. The tactile form of noise is provided for the driver for inducing SR.

The tactile form of noise may be provided for the driver by vibrating a portion of the vehicle that is in physical contact with the driver. The portion of the vehicle in contact with the driver may be a seat, a seat belt, a steering wheel, an accelerator pedal, a brake pedal, a headrest, an armrest, a footrest, a shift lever or the like.

### BRIEF DESCRIPTION OF THE DRAWINGS

Other objects, features and advantages of the present invention will become more apparent from the following detailed description made with reference to the accompanying drawings, in which:

FIG. 1 is a block diagram of a noise generation apparatus in a first and second embodiment of the present invention;

FIG. 2 is an illustration of width of a vehicle;

FIG. 3 is a perspective view for illustrating positions of a head-up display apparatus, a right rear view mirror, a left rear view mirror and a room mirror;

FIG. 4A is a cross-sectional view of the right rear view mirror having a noise generation actuator;

FIG. 4B is a cross-sectional view of the right rear view mirror having a liquid crystal display;

FIG. 5A is an illustration of brightness control in an image displayed on a display device of the head-up display apparatus;

FIG. 5B is an illustration of random light spots displayed on the display device of the head-up display apparatus;

FIG. 6A is a block diagram of a human sensory system;

FIG. 6B a diagram showing a relationship of an input-output characteristic having a threshold;

FIG. 6C is a diagram of the visual noise showing a relationship between a signal to noise ratio and a noise intensity;

FIG. 7A is a diagram of a relationship between the noise intensity and threshold of perception;

FIG. 7B is a diagram of a relationship between a signal intensity and threshold of perception without addition of the noise for SR;

FIG. 7C is a diagram of a relationship between the signal intensity and the threshold of perception with addition of the noise for SR;

FIG. 7D is a diagram of a relationship between an optimum noise intensity and the threshold of perception;

FIG. 8 is a flowchart of a noise generation process in the first and second embodiment;

FIG. 9 is an illustration of a headlight having a liquid crystal shutter in the first embodiment;

FIG. 10 is a block diagram of the noise generation apparatus in a third embodiment;

FIG. 11 is a flowchart of a noise generation process in the third embodiment;

FIG. 12 is a block diagram of the noise generation apparatus in a fourth embodiment;

FIG. 13 is a flowchart of a noise generation process in the fourth embodiment;

FIG. 14 is a block diagram of the noise generation apparatus in a fifth embodiment; and

FIG. 15 is a flowchart of a noise generation process in the fifth embodiment.

### DETAILED DESCRIPTION OF THE PREFERRED EMBODIMENTS

A noise generation apparatus of the present invention is described with reference to the drawings.

### First Embodiment

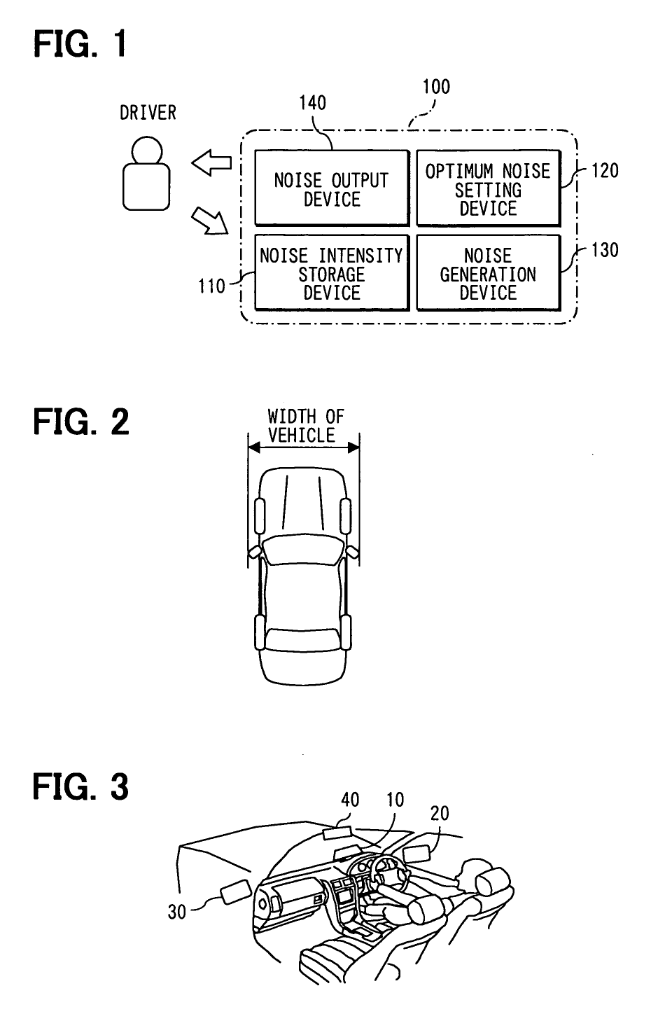

FIG. 1 shows a block diagram of the noise generation apparatus of the present invention. The noise generation apparatus 100 includes a noise intensity storage device 110 for storing a visual noise intensity threshold that is used to induce Stochastic Resonance, an optimum noise setting device 120 for setting an optimum intensity of a noise based on the intensity threshold stored in the noise intensity storage device 110, a noise generation device 130 for generating the noise having the optimum intensity and a noise output device 140 for visually outputting the generated noise.

The noise generation apparatus 100 in the present embodiment is based on a research result regarding “Stochastic Resonance (SR),” disclosed in a thesis entitled “Functional stochastic resonance in the human brain: Noise induced sensitization of baroreflex system” by Hidaka et al., and published in Transaction on Bionics and Physiology Symposium Vol. 15, pp 261-264.

Stochastic resonance (SR) is a phenomenon that improves sensitivity of perception by statistically manipulating a small noise having an intensity below a threshold of perception for an organ of interest such as an eye, an ear or the like. Thus, SR is studied for improving human perception or a similar macro function. The area of improvement may include any macro facility such as perception, nerve control, behavioral operation or the like.

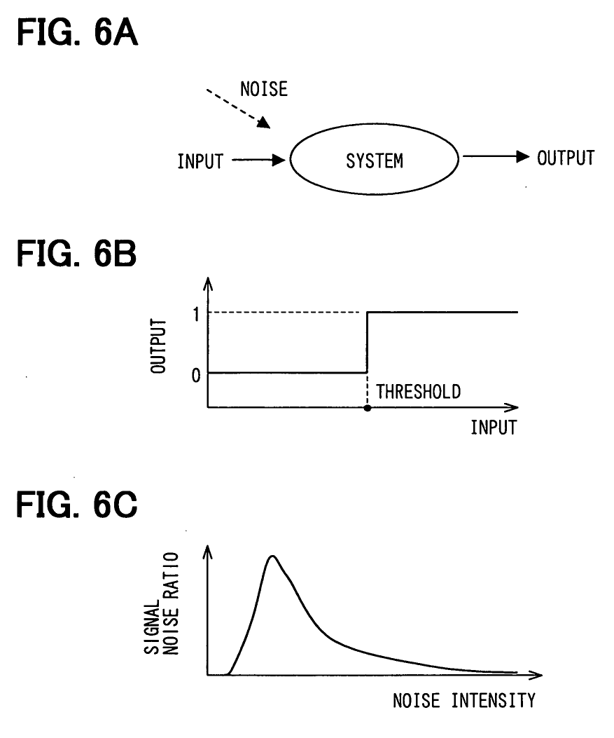

SR is more practically explained with reference to the drawings. FIG. 6A shows an illustration of a human sensory system (e.g., a nerve cell) having a non-linear function. The human sensory system generally responds to an input having an intensity greater than a threshold by yielding an output, as shown in FIG. 6B. Therefore, an input having an intensity below the threshold cannot be detected. However, an input having an intensity below the threshold accompanied by a random noise in a broad frequency band can be perceived by the sensory organ with an assistance of SR effect. That is, SR increases the magnitude of the input and effectively improve the sensitivity of the human sensory system to detect an otherwise un-perceptible input.

An intensity of the random noise for improving the sensitivity of the sensory organ should be carefully chosen in terms of its intensity range. FIG. 6C shows a relationship between a signal to noise ratio (SNR) and the random noise intensity. The relationship shown in the figure indicates that the random noise should neither be too strong nor too weak for a signal of interest (i.e., an input) to be perceived. That is, a certain intensity of the random noise, i.e., the optimum intensity, will maximize the SNR.

The noise generation apparatus 100 uses the optimum intensity to generate the noise. The noise having the optimum intensity is provided for a driver of a vehicle in the present embodiment.

The noise intensity storage device 110 stores the intensity threshold of a visually perceptible random noise (visual noise) constituted from an evenly distributed frequency component over a broad frequency band.

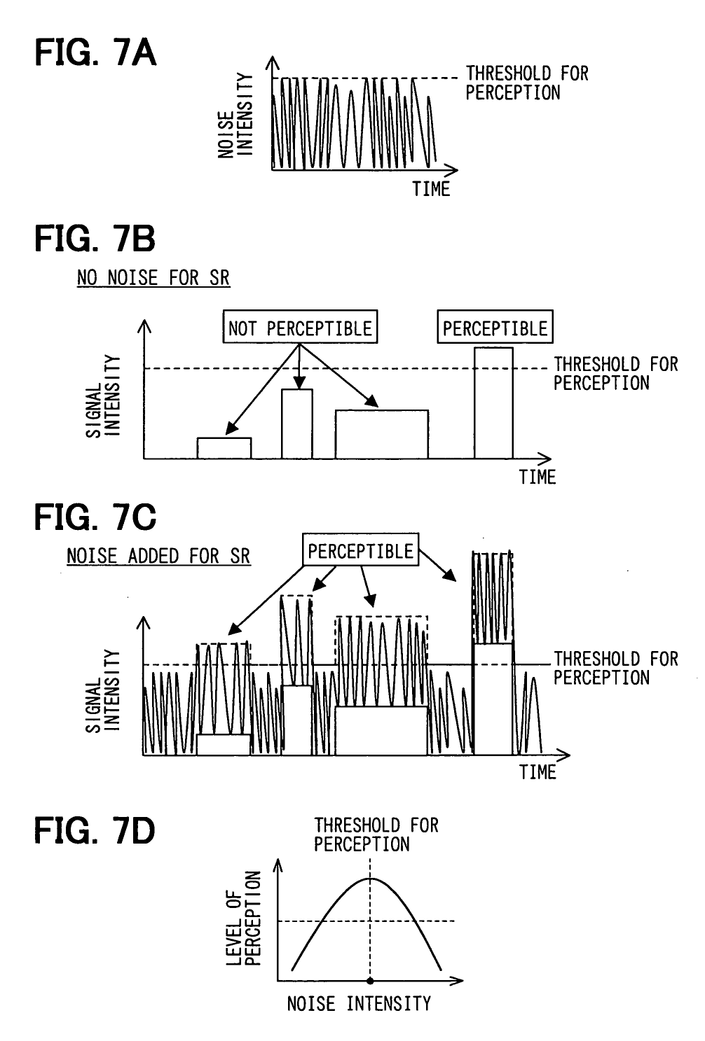

The random noise having a broad band of frequency component is used to induce SR because a signal of interest generally has fluctuation in frequency over a period of observation time. Therefore, a noise having the intensity below threshold for perception as shown in FIG. 7A may be added to the signal of interest for inducing SR. That is, the signal of interest becomes perceptible because the signal of interest stochastically resonates with the added noise to have the intensity greater than the threshold for perception by a human sensory organ as shown in FIG. 7C, even when the signal of interest itself has the intensity below the threshold of perception as shown in FIG. 7B. On the other hand, the noise having a constant frequency (narrow in frequency band) has very low chance to resonate with the signal of interest because fluctuation in frequency component of the signal of interest can not be fully covered by narrowness of frequency band in the added noise.

For example, the random noise having an even distribution of frequency band in terms of the noise intensity, or a 1/f noise having the noise intensity in inverse proportion to an increase of frequency may be used to induce SR between the signal of interest and the provided noise. The noise intensity storage device 110 stores the intensity threshold for effectively inducing SR.

The noise generation apparatus 100 includes a threshold setting device (not shown in the figure) for finding and storing the threshold of the noise intensity. The threshold of the noise intensity is determined in a course of gradual increase of the noise by recognizing a first perception of the noise by the driver. Then, the threshold of the noise intensity is stored in the noise intensity storage device 110.

In this manner, the threshold for visual perception by the driver is determined and stored. The threshold setting device includes an operation switch for accepting driver's operation, and a noise intensity detector for detecting the noise intensity in the noise generation device 130 when the operation switch is manipulated (both of the operation switch and the noise intensity detector are not shown in the figure).

The threshold of the noise intensity stored in the noise intensity storage device 110 may be adjusted for accommodating health condition of the driver because sensitivity of the sensory organ of the driver may vary according to the health condition. The threshold stored in the noise intensity storage device 110 may be adjustably controlled by an adjuster (not shown in the figure).

The optimum noise setting device 120 sets the intensity of the optimum intensity of the random noise. The optimum intensity of the random noise is determined as 100±18% of the threshold of the noise intensity of the random noise. The optimum noise setting device 120 also sets the optimum intensity of a 1/f noise. The optimum intensity of the 1/f noise is determined as 69±12% of the threshold of the noise intensity of the random noise.

The optimum noise intensity of the random noise and the 1/f noise used to induce SR is preferably in a range close to the threshold of perception as shown in FIG. 7D. That is, the human sensory organ cannot perceive the signal of interest because of an insufficient resonance when the provided noise is too low in intensity, and cannot perceive the signal of interest because of overabundance of resonance when the provided noise is too high in intensity.

The optimum noise intensity is carefully examined through experiment by the inventors. Results of the experiment shows that the noise intensity of 100±18% of the intensity threshold for perception best serves for SR when the noise is the random noise, and the noise intensity of 69±12% of the intensity threshold for perception best serves for SR when the noise is the 1/f noise.

The result of the experiment corresponds to a well-known general knowledge in the art of engineering that the 1/f noise yields the same effect as a “white noise,” i.e., a type of random noise, by approximately 70% in the intensity of the white noise. In this manner, the optimum noise intensity for various types of noises can be determined.

The noise generation device 130 generates the random noise or the 1/f noise in a form of visual representation based on the optimum intensity determined by the optimum noise setting device 120. For example, the noise may be represented by flickering light or a change of a position of an object, to be outputted from the noise output device 140. The generated noise is transferred to the noise output device 140 as a noise signal.

The noise output device 140 provides the visual noise generated by the noise generation device 130 for the driver. FIG. 3 shows a right rear view door mirror 20, a left rear view door mirror 30 and a room mirror 40 in the first embodiment. These mirrors include noise generation actuator for generating vibration to surfaces of the mirrors.

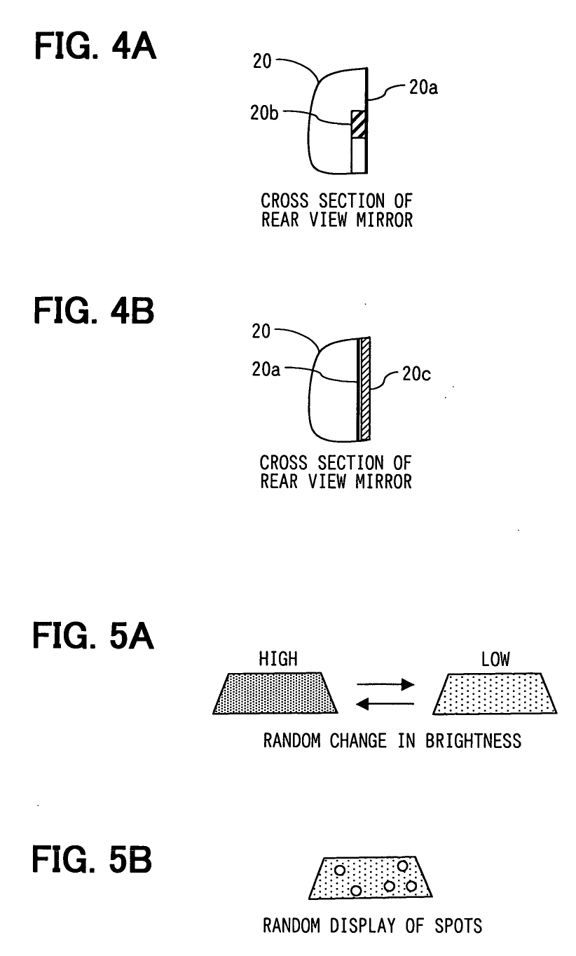

FIG. 4A shows a cross section of the right rear view door mirror 20. In this case, the noise output device 140 receives the noise signal for driving the noise generation actuator 20b from the noise generation device 130, and outputs the noise signal to the noise generation actuator 20b for vibrating a mirror surface 20a.

In this manner, the visually represented noise is provided for the driver by vibrating the mirror surfaces of the mirrors disposed outside of the vehicle on the doors or the like, or the mirrors inside the vehicle.

The noise output devices 140 are preferably arranged in a lateral direction in a front space of the driver's seat, and are spaced to each other in an interval smaller than the width of the vehicle. In this manner, the visually represented noise is continuously provided in a driver's sight.

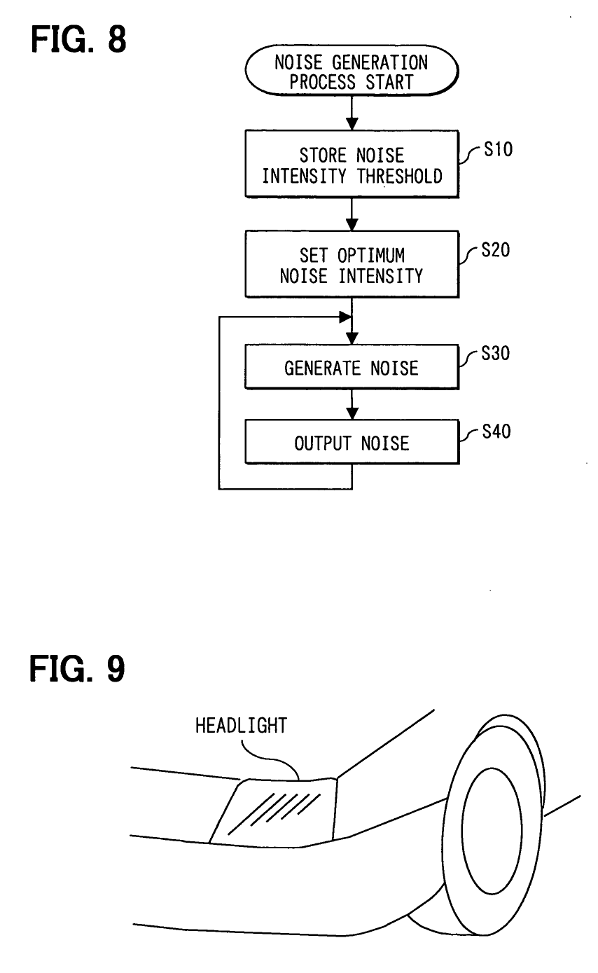

A noise generation process in the first embodiment is described with reference to a flowchart in FIG. 8. The process starts with step S10 after the noise generation apparatus 100 is turned on. In step S10, the threshold of the noise intensity is stored when the intensity of the gradually increased noise from the noise output device 140 reaches a perceptible level by the sensory organ of the driver.

In step S20, the optimum intensity of the random noise or the optimum intensity of the 1/f noise is determined. The optimum intensity of the random noise is set to 100% of the threshold of the noise intensity stored in step S10, and the optimum intensity of the 1/f noise is set to 69% of the intensity of the random noise.

In step S30, either of the visually represented random noise or the visually represented 1/f noise having the optimum intensity determined in step S20 is generated. In step S40, the generated noise in step S30 is outputted. Then, steps S30 and S40 are repeated.

The noise generation apparatus 100 in the first embodiment determines the optimum intensity of the visually perceptible noise based on the threshold of the noise intensity, generates the noise having the optimum intensity, and provides the generated noise for the driver.

In this manner, perception of the driver such as visual recognition of an object or the like is improved. As a result, the driver acquires an improved awareness of an environmental condition of the subject vehicle. Therefore, the driver becomes capable of preventing oversight of an object in need of driver's attention, and thus traveling condition of the vehicle is improved.

The noise output device 140 uses the right rear view door mirror 20, the left rear view door mirror 30 and the room mirror 40 to output the visual noise. More practically, the position of the object in the vision of the driver is moved by vibration of the mirror surfaces to visually output the noise. However, the light in the vision of the driver may be used to represent the visual noise.

For example, the noise output device 140 may include a display device, and an image displayed on the display device may be used to represent the visual noise by changing brightness of the image or the like, and/or by randomly displaying a spot pattern in the image.

FIG. 5A shows an example of an image displayed on a display device of a head-up display apparatus 10 in FIG. 3. The brightness of the image on the display device randomly changes to output the visual noise.

FIG. 4B shows a liquid crystal display device 20c disposed on the mirror surface 20a of the right rear view door mirror 20. The brightness of the image on the liquid crystal display device 20c may be randomly changed for outputting the visual noise. The left rear view door mirror 30 and the room mirror 40 may have the same structure as the right rear view door mirror 20. Random change may be applied for at least one of attributes of the image such as illuminance, luminosity, chroma and color besides changing brightness. Further, as shown in FIG. 5B, the object in the image such as a spot or the like may be randomly displayed or randomly moved to output the visual noise.

Further, the visual noise may be provided from a display device of a navigation system or other existing system beside the display device of the head-up display apparatus 10.

Furthermore, the visual noise may be provided by randomly changing the light from a headlight. That is, transparency of a liquid crystal shutter disposed in front of the headlight cover may be randomly changed to output the visual noise. In this manner, the visual noise represented by change in brightness of the light is provided for the driver.

### Second Embodiment

A second embodiment of the present invention is described with reference to the drawings. Focus of the description of the second embodiment is put on the difference between the first embodiment and the second embodiment.

The noise generation apparatus 100 in the second embodiment induces Stochastic Resonance by providing a tactile noise for the driver of the vehicle.

A scheme of the noise generation apparatus 100 is the same as the apparatus 100 in the first embodiment shown in FIG. 1. That is, the noise generation apparatus 100 includes a noise intensity storage device 110 for storing a tactile noise intensity threshold that is used to induce Stochastic Resonance, an optimum noise setting device 120 for setting an optimum intensity of a noise based on the intensity threshold stored in the noise intensity storage device 110, a noise generation device 130 for generating the noise having the optimum intensity and a noise output device 140 for tactually outputting the generated noise.

The noise intensity storage device 110 stores the intensity threshold of a tactually perceptible random noise (tactile noise) constituted from an evenly distributed frequency component over a broad frequency band.

The optimum noise setting device 120 sets the intensity of the optimum intensity of the random noise. The optimum intensity of the random noise is determined as 100±18% of the threshold of the noise intensity of the random noise. The optimum noise setting device 120 also sets the optimum intensity of a 1/f noise. The optimum intensity of the 1/f noise is determined as 69±12% of the threshold of the noise intensity of the random noise.

The noise generation device 130 generates the random noise or the 1/f noise in a form of tactile representation based on the optimum intensity determined by the optimum noise setting device 120. The generated noise is transferred to the noise output device 140 as a noise signal.

The noise output device 140 provides the tactile noise generated by the noise generation device 130 for the driver. The noise output device 140 includes a noise generation actuator (a motor driven vibrator or the like) disposed at a portion of the vehicle that is in contact with a body of the driver for outputting the generated noise.

For example, the noise generation actuator uses following parts to provides the tactile noise. That is, a seat, a seat belt, a steering wheel, an accelerator pedal, a brake pedal, a headrest, an armrest, a footrest, a shift lever or the like in contact with the driver is used to output the tactile noise to the driver.

A noise generation process in the second embodiment is described with reference to the flowchart in FIG. 8. The process starts with step S10 after the noise generation apparatus 100 is turned on. In step S10, the threshold of the noise intensity is stored when the intensity of the gradually increased noise from the noise output device 140 reaches a perceptible level by the sensory organ of the driver.

In step S20, the optimum intensity of the random noise or the optimum intensity of the 1/f noise is determined. The optimum intensity of the random noise is set to 100% of the threshold of the noise intensity stored in step S10, and the optimum intensity of the 1/f noise is set to 69% of the intensity of the random noise.

In step S30, either of the tactually represented random noise or the tactually represented 1/f noise having the optimum intensity determined in step S20 is generated. In step S40, the generated noise in step S30 is outputted. Then, steps S30 and S40 are repeated.

The noise generation apparatus 100 in the second embodiment determines the optimum intensity of the tactually perceptible noise based on the threshold of the noise intensity, generates the noise having the optimum intensity, and provides the generated noise for the driver to tactually induce Stochastic Resonance.

### Third Embodiment

A third embodiment of the present invention is described with reference to the drawings. Focus of the description of the third embodiment is put on the difference between the first/second embodiments and the third embodiment.

The noise generation apparatus 100 in the third embodiment induces Stochastic Resonance by providing an auditory noise for the driver of the vehicle.

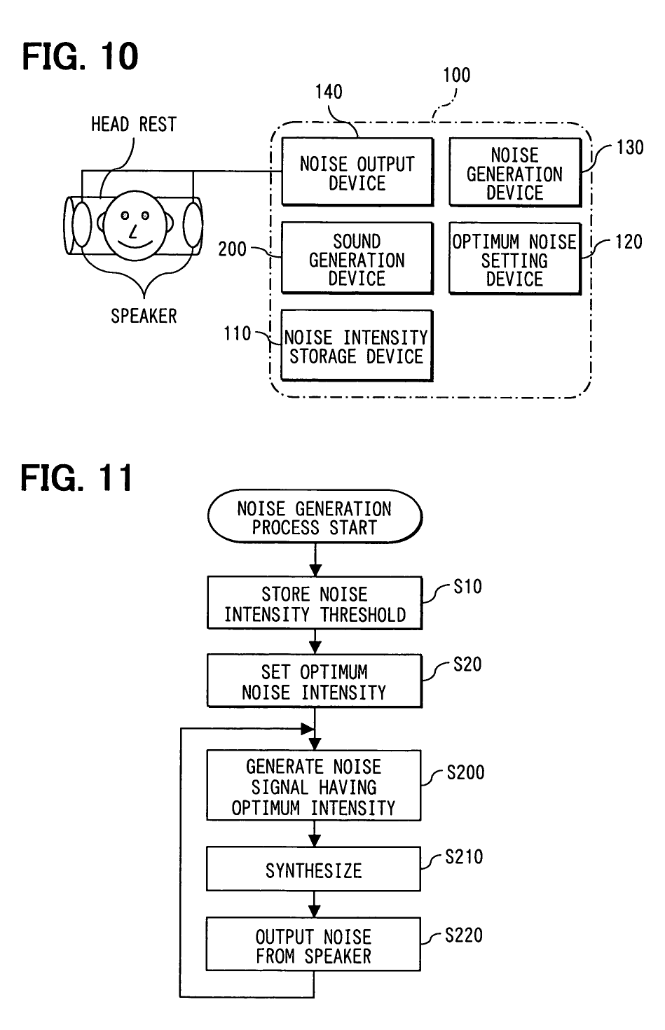

A scheme of the noise generation apparatus 100 is shown in FIG. 10. That is, the noise generation apparatus 100 includes a noise intensity storage device 110 for storing an auditory noise intensity threshold that is used to induce Stochastic Resonance, an optimum noise setting device 120 for setting an optimum intensity of a noise based on the intensity threshold stored in the noise intensity storage device 110, a noise generation device 130 for generating a noise signal having the optimum noise intensity, a sound generation device 200 for generating a sound signal and a noise output device 140 for audibly outputting the noise synthesized from the noise signal and the sound signal through a speaker.

The noise intensity storage device 110 stores the intensity threshold of a audibly perceptible random noise (auditory noise) constituted from an evenly distributed frequency component over a broad frequency band.

The optimum noise setting device 120 sets the intensity of the optimum intensity of the random noise. The optimum intensity of the random noise is determined as 100±18% of the threshold of the noise intensity of the random noise. The optimum noise setting device 120 also sets the optimum intensity of a 1/f noise. The optimum intensity of the 1/f noise is determined as 69±12% of the threshold of the noise intensity of the random noise.

The noise generation device 130 generates the random noise or the 1/f noise in a form of auditory representation based on the optimum intensity determined by the optimum noise setting device 120. The generated noise is transferred to the noise output device 140 as a noise signal.

The sound generation device 200 generates the sound signal for outputting sound from the speaker, and transfers the sound signal to the noise output device 140. The noise output device 140 outputs a synthesized signal to the speaker. The synthesized signal is synthesized from the noise signal of the auditory noise from the noise generation device 130 and the sound signal from the sound generation device 200. The sound generation device 200 is only provided when the noise signal is synthesized with the sound signal. That is, the noise signal may be outputted from the speaker by itself.

The auditory noise in the present embodiment is outputted from a sound source such as the speaker as shown in FIG. 10. In this manner, the auditory noise is provided for the driver of the vehicle. The speaker for outputting the auditory noise may be disposed in a head rest, a door, a seat, a roof, an instrument panel or the like. In this manner, the auditory noise is securely provided for the driver.

Further, as shown in FIG. 10, the speaker disposed in the head rest provides the auditory noise only for the driver of the vehicle.

A noise generation process in the third embodiment is described with reference to a flowchart in FIG. 11. The process starts with step S10 after the noise generation apparatus 100 is turned on. In step S10, the threshold of the noise intensity is stored when the intensity of the gradually increased auditory noise from the noise output device 140 reaches a perceptible level by the sensory organ of the driver.

In step S20, the optimum intensity of the random noise or the optimum intensity of the 1/f noise is determined. The optimum intensity of the random noise is set to 100% of the threshold of the noise intensity stored in step S10, and the optimum intensity of the 1/f noise is set to 69% of the intensity of the random noise.

In step S200, either of the auditory represented random noise or the auditory represented 1/f noise having the optimum intensity determined in step S20 is generated as the noise signal. In step S210, the auditory noise is synthesized from the noise signal generated in step S200 and the sound signal from the sound generation device 200. In step S220, the generated auditory noise is outputted from the speaker. Then, steps S200 to S220 are repeated.

The noise generation apparatus 100 in the third embodiment determines the optimum intensity of the audibly perceptible noise based on the threshold of the noise intensity, generates the noise having the optimum intensity as the noise signal, and provides the generated noise for the driver to audibly induce Stochastic Resonance.

### Fourth Embodiment

A fourth embodiment of the present invention is described with reference to the drawings. Focus of the description of the fourth embodiment is put on the difference from the preceding description of the embodiments.

The noise generation apparatus 100 in the fourth embodiment induces Stochastic Resonance by providing the noise in variable intensity and/or to variable types of sensory organs. This is intended to avoid decrease of effectiveness of Stochastic Resonance because of fatigue or the like of the sensory organ caused by a continuous stimulation the random noise over a period of time.

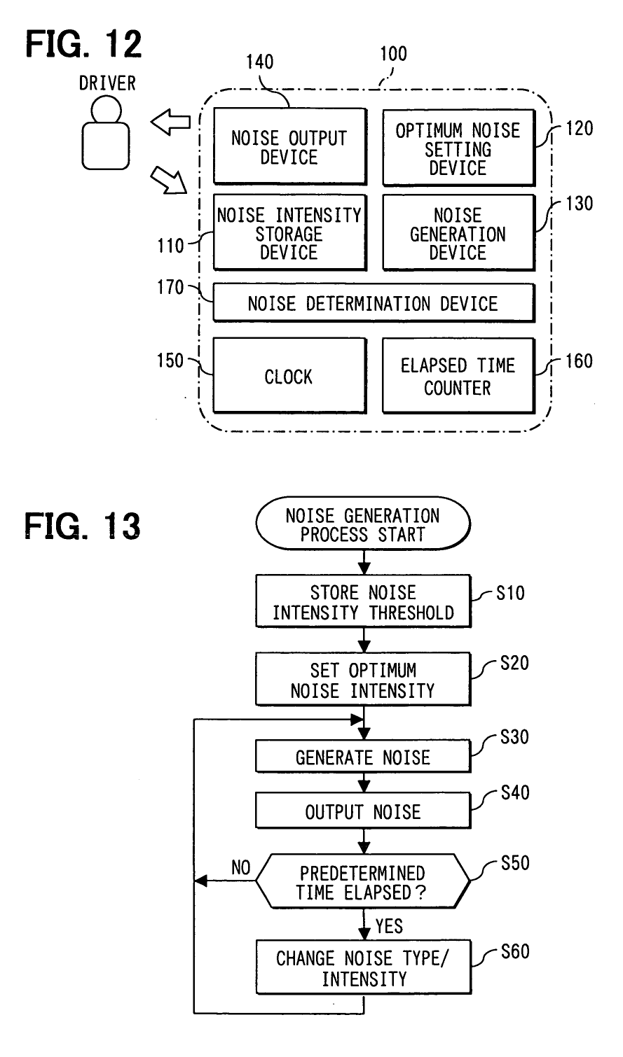

FIG. 12 shows a block diagram of the noise generation apparatus 100 in the fourth embodiment. The noise generation apparatus 100 in the present embodiment includes a clock 150, an elapsed time counter 160 and a noise determination device 170 besides including the noise intensity storage device 110, the optimum noise setting device 120, the noise generation device 130 and the noise output device 140.

Description regarding the noise intensity storage device 110, the optimum noise setting device 120, the noise generation device 130 and the noise output device 140 is omitted because those devices have the same functions as described in the first embodiment.

The clock 150 provides time count for the elapsed time counter 160. The elapsed time counter 160 determines whether the elapsed time of noise generation by the noise output device 140 surpasses a predetermined period for causing fatigue of the sensory organ or the like (fatigue time). The fatigue time is determined based on an experiment or the like. The noise determination device 170 receives determination result from the elapsed time counter 160.

The noise determination device 170 changes type and intensity of the random noise when it receives the determination result from the elapsed time counter 160 that indicates the elapsed time surpassed the predetermined period. That is, the type of the noise (the random noise or the 1/f noise) and the optimum intensity of the noise are changed, and the change is reflected to the noise generated by the noise generation device 130.

The optimum intensity of the noise is changed within the range described above in the preceding embodiments. That is, the random noise is changed within the range of 100±18% of the intensity threshold of the random noise, and the 1/f noise is changed within the range of 69±12% of the intensity threshold of the random noise.

Ratio of change against a current intensity and/or timing of change of the noise type are determined based on an experiment or the like.

A noise generation process in the fourth embodiment is described with reference to a flowchart in FIG. 13. Steps S10 to S40 are the same as corresponding steps in the first embodiment. Therefore, description of those steps is omitted.

In step S50, the elapsed time of noise generation is examined. The noise generation process proceeds to step S60 when the elapsed time is determined to be greater than the predetermined fatigue time. The process returns to step S30 when the elapsed time is determined to be smaller than the predetermined fatigue time, and the above process is repeated.

In step S60, the noise type and/or the noise intensity are changed. The process returns to step S30 for outputting the noise to effectively induce the Stochastic Resonance after changing the noise type and/or the noise intensity. In this manner, noise generation time for effectively inducing Stochastic Resonance is extended.

### Fifth Embodiment

A fifth embodiment of the present invention is described with reference to the drawings. Focus of the description of the fourth embodiment is put on the difference from the preceding description of the embodiments.

The noise generation apparatus 100 in the present embodiment stores a history of the threshold of the noise intensity that defines perception of the noise by the driver, examines the stored thresholds for calculation based on the stored thresholds and changes the optimum intensity of the noise based on the examination and calculation of the stored thresholds when a total noise generation time reaches a predetermined period of time (e.g., 1000 hours). In the present embodiment, the optimum intensity of the visual noise is prepared for the driver of the vehicle.

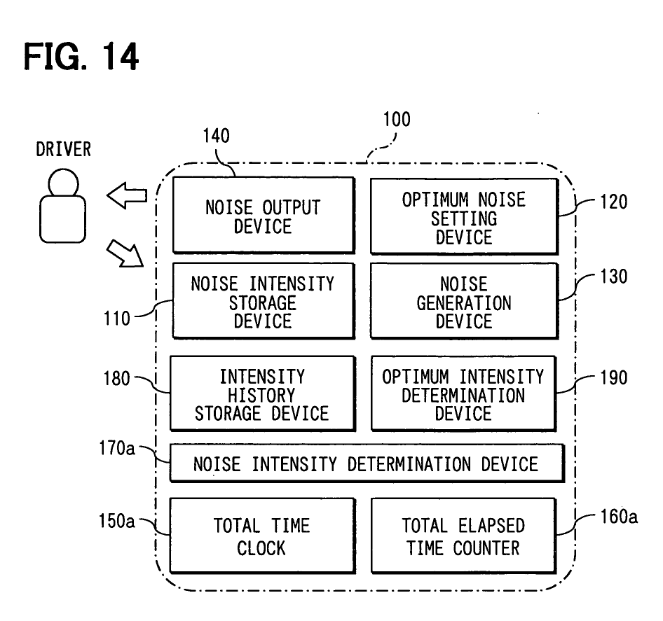

FIG. 14 shows a block diagram of the noise generation apparatus 100 in the fifth embodiment. The noise generation apparatus 100 includes a total time clock 150a, a total elapsed time counter 160a, an intensity determination device 170a, an intensity history storage device 180 and an optimum intensity determination device 190 besides including the noise intensity storage device 110, the optimum noise setting device 120, the noise generation device 130 and the noise output device 140.

Description regarding the noise intensity storage device 110, the optimum noise setting device 120, the noise generation device 130 and the noise output device 140 is omitted because those devices have the same functions as described in the first embodiment.

The total time clock 150a provides time count of total noise generation time for the total elapsed time counter 160a. The total elapsed time counter 160a determines whether the total noise generation time reaches to a predetermined period of time (e.g., 1000 hours). The determination result is transferred to the intensity determination device 170a.

The intensity determination device 170a changes the optimum noise intensity based on the examination and calculation by the optimum intensity determination device 190. The changed intensity is used to generate the noise in the noise generation device 130.

The optimum noise intensity is changed within the range described above in the preceding embodiments. That is, the random noise is changed within the range of 100±18% of the intensity threshold of the random noise, and the 1/f noise is changed within the range of 69±12% of the intensity threshold of the random noise.

The intensity history storage device 180 collects the intensity thresholds stored in the noise intensity storage device 110. The optimum intensity determination device 190 examines the collected thresholds to determine the optimum intensity based on the collected intensity thresholds.

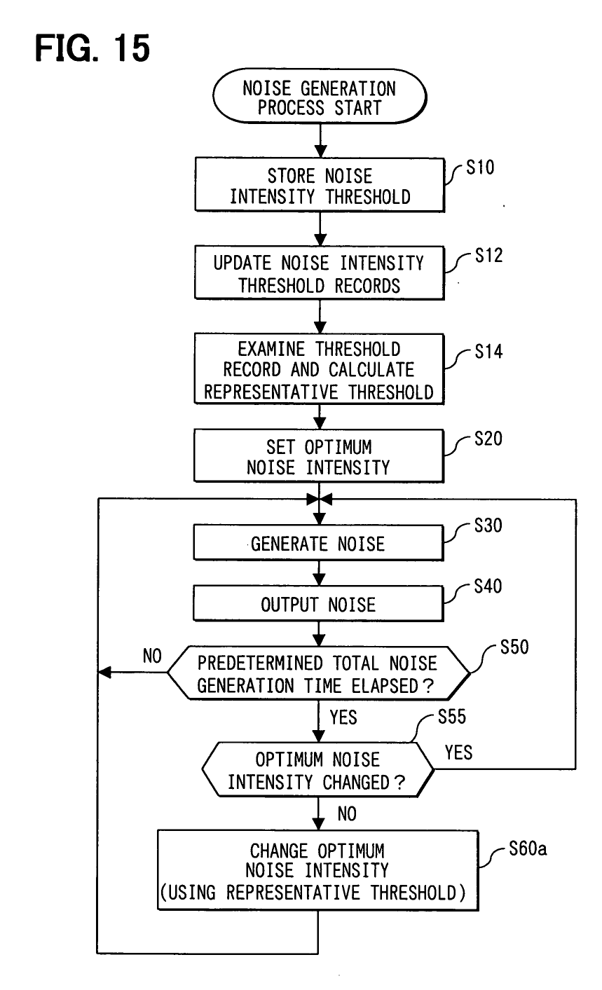

A noise generation process in the fourth embodiment is described with reference to a flowchart in FIG. 15. The process starts with step S10 after the noise generation apparatus 100 is turned on. In step S10, the threshold of the noise intensity is stored when the intensity of the gradually increased noise from the noise output device 140 reaches a perceptible level by the sensory organ of the driver.

In step S12, the threshold of the noise intensity stored in step S10 is recorded together with the thresholds stored in a preceding cycle of the process.

In step S14, the stored thresholds are examined and calculated to determine a threshold of the noise intensity being representative of all stored thresholds.

In step S20, the optimum intensity of the random noise or the optimum intensity of the 1/f noise is determined. The optimum intensity of the random noise is set to 100% of the threshold of the noise intensity stored in step S10, and the optimum intensity of the 1/f noise is set to 69% of the intensity of the random noise.

In step S30, either of the visually represented random noise or the visually represented 1/f noise having the optimum intensity determined in step S20 is generated. In step S40, the generated noise in step S30 is outputted.

Count of the total noise generation time begins when the visual noise is generated in step S40. In step S50, the total noise generation time is examined. The noise generation process proceeds to step S55 when the total noise generation time is determined to be greater than the predetermined period of time. The process returns to step S30 when the total noise generation time is determined to be smaller than the predetermined period of time, and the above process is repeated.

In step S55, the optimum noise intensity is examined. The process returns to step S30 when the optimum noise intensity is determined as changed based on the examination and calculation of the stored thresholds of the noise intensity. The above-described process is repeated. The process proceeds to step S60a when the optimum noise intensity is determined as not changed. The optimum noise intensity is changed in step S60a based on the noise intensity being representative of all stored thresholds of the noise intensity.

The process does not use the thresholds of the noise intensity after the optimum intensity is changed in step S60a. The noise generation process repeats steps after step S20. That is, the optimum noise intensity is automatically determined for the visual noise, and the visual noise is outputted based on the optimum noise intensity.

The noise generation apparatus 100 in the fifth embodiment determines the optimum intensity of the visually perceptible noise based on the threshold of the noise intensity historically stored for examination and calculation, generates the visual noise having the representative intensity of the stored noise intensities based on the examination and calculation, and provides the generated noise for the driver to visually induce Stochastic Resonance. In this manner, the optimum noise intensity of the noise generation apparatus 100 is adjusted to an individual driver of the vehicle.

Although the present invention has been fully described in connection with the preferred embodiments thereof with reference to the accompanying drawings, it is to be noted that various changes and modifications will become apparent to those skilled in the art.

What is claimed is:

1. A noise generator comprising:
a noise intensity storage means for storing a noise intensity threshold of a noise;
a noise intensity setting means for setting an optimum noise intensity based on the noise intensity threshold;
a noise generation means for generating the noise based on the optimum noise intensity; and
a noise output means for outputting the noise generated by the noise generation means,
wherein the noise intensity threshold is determined upon perception of the noise.

2. The noise generator according to claim 1,
wherein the noise intensity storage means stores the noise intensity threshold of a random noise having an uniform distribution of frequency component in a range of frequency,
the noise intensity setting means sets the optimum noise intensity of the random noise to 100±18% of the noise intensity threshold of the random noise, and
the noise intensity setting means sets the optimum noise intensity of a 1/f noise in inversely proportional relationship to an increase of the frequency to 69±12% of the noise intensity threshold of the random noise.

3. The noise generator according to claim 1 further comprising a changing means for changing at least one of a noise type and the optimum noise intensity of the noise.

4. The noise generator according to claim 3 further comprising:
a clock for counting an elapsed time after start of noise generation by the noise generation apparatus; and
a timer for determining whether a predetermined amount of time has elapsed,
wherein the changing means changes at least one of the noise type and the optimum noise intensity of the noise when the predetermined amount of time has elapsed.

5. The noise generator according to claim 3 further comprising:
an intensity recording means for recording the noise intensity thresholds stored by the noise intensity storage means; and
an intensity representation means for calculating a representative noise intensity threshold based on the noise intensity thresholds recorded by the intensity recording means,
wherein the changing means changes the noise intensity threshold of the optimum noise intensity based on the representative noise intensity thresholds.

6. The noise generator according to claim 3 further comprising a control means for controlling the noise intensity threshold stored by the noise intensity storage means,
wherein the changing means changes the noise intensity threshold of the optimum noise intensity.

7. The noise generator according to claim 1 further comprising a threshold definition means for finding the noise intensity threshold by gradually increasing the noise intensity to a level of perception by a sensory organ.

8. The noise generator according to claim 1,
wherein use of the noise generator is intended in an automotive vehicle, and
the noise output means outputs the noise to a driver of the automotive vehicle.

9. The noise generator according to claim 8,
wherein the noise intensity storage means stores the noise intensity threshold of a visible noise being perceptible by visual perception of the driver,
the noise generation means generates the visible noise, and
the noise output means outputs the visible noise.

10. The noise generator according to claim 9,
wherein the noise output means is disposed at a front space of a driver's seat in a plurality of units laterally arranged within a width of the automotive vehicle.

11. The noise generator according to claim 10,
wherein the noise output means outputs the visible noise by vibrating a surface of a mirror used either in or on the vehicle.

12. The noise generator according to claim 9 further comprising a transparent liquid crystal display device for variably obstructing a light emitted from a light source of the automotive vehicle,
wherein the noise output means uses the transparent liquid crystal display device to output the visible noise.

13. The noise generator according to claim 10,
wherein the noise output means includes a display device, and
the visible noise is outputted from the display device of the noise output means.

14. The noise generator according to claim 13,
wherein the display device is a liquid crystal display device disposed on a surface of a mirror used either in or on the vehicle.

15. The noise generator according to claim 13,
wherein the display device is a component of at least one of a head-up display device, a navigation device and a similar type of device.

16. The noise generator according to claim 8,
wherein the noise intensity storage means stores the noise intensity threshold of an audible noise being perceptible by auditory perception of the driver,
the noise generation means generates the audible noise, and
the noise output means outputs the audible noise.

17. The noise generator according to claim 16,
wherein the noise output means is positioned within an area defined by a reach of an auditory perception of the driver.

18. The noise generator according to claim 16,
wherein the noise output means includes an audible signal emission device in the automotive vehicle.

19. The noise generator according to claim 8,
wherein the noise intensity storage means stores the threshold of an tactual noise being perceptible by tactile perception of the driver,
the noise generation means generates the tactile noise, and
the noise output means outputs the tactile noise.

20. The noise generator according to claim 19,
wherein the noise output means includes a vibration generation device, and
the vibration generation device is in physical contact with the driver in the automotive vehicle.
